(19) United States
(12) Patent Application Publication
(10) Pub. No.: US 2009/0154670 A1
(43) Pub. Date: Jun. 18, 2009

(54) Providing Advanced Calling Features from a Multimedia Terminal Adaptor

(75) Inventors: Christopher Cotignola, Doylestown, PA (US); Jacob Igval, Newtown, PA (US); Dipak Patel, Hatboro, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/957,003

(22) Filed: Dec. 14, 2007

(51) Int. Cl. H04M 11/00

(52) U.S. Cl. 379/93.01

(57) ABSTRACT

An incoming call is received. Prior to transmitting a first ringing signal for the incoming call, an advanced calling feature signal is transmitted to customer premises equipment (CPE) on a local line at the customer premises. Then, the first ringing signal is transmitted to the CPE via the local line.

### BACKGROUND

Service providers are trying to push as many different services as possible to customers in order to maximize revenue. Many of these services are provided via an Internet Protocol (IP) network to the customer premises. For example, digital services, such as high-speed Internet, voice-over-Internet-Protocol (VoIP), streaming video, etc., are provided via an IP network to the customer premises. Some of these services, such as VoIP, are provided via a multimedia terminal adapter (MTA) located at the customer premises. The MTA is connected to a local loop at the customer premises. The local loop is usually comprised of twisted-pair, RJ-11 wiring, which is telephone wiring commonly provided in homes and businesses. The MTA is commonly provided with a modem in a single device, referred to as an embedded MTA (EMTA), but the MTA and modem may also be provided as separate devices. Many service providers offer voice-over-Internet-Protocol (VoIP) service through the EMTA.

Currently, EMTAs can deliver, via the RJ-11, basic ringing capabilities to a telephone or other customer premises equipment (CPE) connected to the RJ-11. This consists of the EMTA generating an alternating voltage between tip and ring wires on the RJ-11. This signal causes the telephone to activate its ringer. The ring signal is generic, mostly meant to identify the user of an incoming call.

The cadence and timing of ringing can currently be altered by the EMTA. This is achieved by the EMTA generating its ring signal using different duty cycles (the on-off timing bursts), and the overall cadence. However, the result is still the same generic ring signal, just the pattern of the ring has changed. However, the audio of the ring cannot be altered through the EMTA. This is due to the EMTA currently complying with the Bellcore/Telcordia requirements that are designed to drive the POTS.

The mobile phone market has captured revenues from users wanting a distinctive ring capability and advanced ringing performance. However, this technology was never able to be ported to the wired telephony points, e.g., residential, small office/home office (SOHO), etc., due to the analog interface the phone devices were connected to, such as the RJ-11, and the Bellcore/Telcordia requirements that are designed to drive the POTS.

### BRIEF DESCRIPTION OF THE DRAWINGS

Embodiments are illustrated by way of example and not limited in the following Figure(s), in which like numerals indicate like elements, in which:

FIG. 1 illustrates a system, according to an embodiment;

FIG. 2 illustrates a method of providing advanced calling features, according to an embodiment;

FIG. 3 illustrates an EMTA, according to an embodiment; and

FIG. 4 illustrates CPE, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

According to an embodiment, a system provides advanced calling features for CPE connected to local wiring. The advanced calling features may include performance ringing. This may include providing different ring tones. The ring tones may be customized, such that they are different than a conventional ring or different than a convention ring provided in a different cadence. These ring tones may include MP3 files, polymorphic ring tones, ring tones downloaded from the Internet, etc. Advanced calling features may also include providing multimedia instead of a conventional ring, such as a picture or streaming video along with a ring tone.

The system includes an MTA at the customer premises that is configured to transmit signals to CPE to provide the advanced calling features. The CPE is operable to process the signals and provide the advanced calling features. The MTA can transmit the signals on existing RJ-11 at the customer premises. Also, the signals do not interfere with conventional, legacy, CPE connected to the RJ-11 that is not capable of providing the advanced calling features. Thus, the Telcordia/Bellcore specifications for providing telephony services via RJ-11, such as tip and ring voltages, are not violated by the system. Also, service providers may use the system to possibly generate revenue by offering the advanced calling features to their customers.

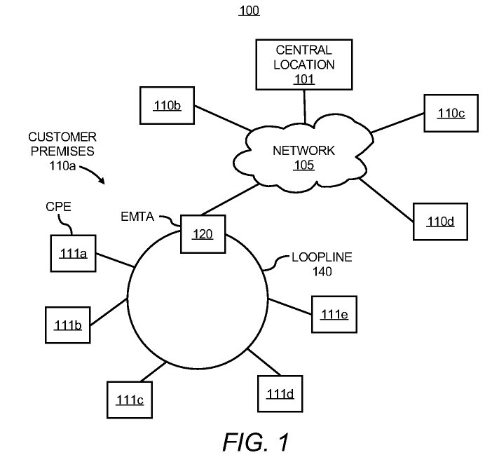

FIG. 1 illustrates a system 100, according to an embodiment. The system 100 includes a central location 101 transmitting data to a plurality of customer premises 110a-n via a network 105. The central location 101 may include a cable head-end or a central office providing communication services to the customer premises 110a-n. The network 105 may include an IP network for providing digital communication services, such as VoIP, high-speed Internet connection, cable television, etc., or the network 105 may include a circuit-switched POTS network. The digital communication services may include a, VoIP, and satellite services, etc.

The customer premises 110a-n may include EMTAs for providing VoIP and other services. For example, the customer premise 110a is shown with EMTA 120. Although not shown, one or more of the remaining customer premises 110b-n may include an EMTA. Also, MTAs and modems may each be provided as standalone devices or as EMTAs. In one embodiment, the EMTA 120 includes a cable modem. However, the modem may include a DSL modem, satellite modem, or other types of modems.

CPE devices 111a-e at the customer premises 110a are connected to a local line, referred to as the loop line 140. Examples of CPE devices include phones, cordless telephone base station, home security systems, answering machines, facsimiles, and others. The loop line 140 may include conventional twisted pair loop wiring comprised of RJ-11.

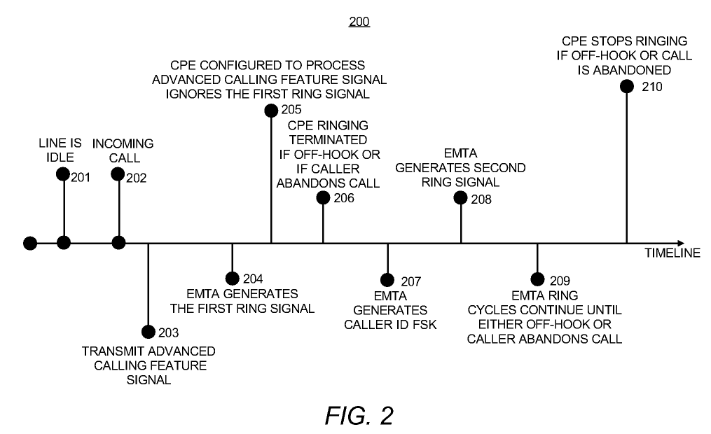

According to an embodiment, the EMTA 120 is operable to provide advanced calling features for the CPE 111a-e. FIG. 2 illustrates a method 200 for providing advanced calling features. FIG. 2 is described with respect to the system 100 shown in FIG. 1 by way of example.

At 201, a telephone line, such as the loopline 140 at the customer premises 110a, is idle. For example, the telephone line is not busy. At 202, there is an incoming call. For example, the EMTA 120 shown in FIG. 1 receives a call from the customer premises 110d.

At 203, an advanced calling feature signal is transmitted on the loopline 140 to the CPE 111a-e, and at 204 a first ring signal is generated on the loopline 140. The advanced calling feature signal at 203 includes data instructing CPE 111a-e to provide an advanced calling feature. For example, the EMTA 120 transmits the advanced calling feature signal on the loopline 140 to CPE 111a-e. The advanced calling feature signal may identify a particular ringtone or particular media, such as a picture, video clip, audio clip, etc., to play at the CPE 111a-e. Any of the CPE 111a-e that is configured to provide advanced calling features play the ring tone.

The advanced calling feature signal may include digital data modulated using an analog modulation technique for transmission on the loopline 140. One example of an analog modulation technique that may be used is frequency-shift-keying (FSK). Any of the CPE 111a-e that is configured to process an advanced calling feature signal listens for the FSK advanced calling feature signal transmitted by the EMTA 120 on the loopline 140. The advanced calling feature signal includes discrete data, for example, that instructs the CPE 111a-e to play a particular ring tone.

The first ring signal is generated at 204 after the advanced calling feature signal is transmitted on the loopline 140 to the CPE 111a-e. The first ring signal is a conventional tip and ring signal that consists of an alternating voltage between tip and ring wires on the RJ-11 of the loopline 140. This signal causes telephones and other conventional CPE connected to the loopline 140 to ring, thus alerting a user of the incoming call. The first ring signal also alerts conventional circuitry in phones to prepare for a following FSK signal that contains caller ID information.

Legacy CPE that is not configured to process an advanced calling feature signal ignores the advanced calling feature signal because it is transmitted prior to the first ring signal. Conventionally, an EMTA may transmit an FSK signal with caller ID information to CPE after the first ring signal. Thus, the first ring signal operates, in addition to a ring signal, as an alert signal for caller ID information. However, the EMTA according to the embodiments sends the advanced calling feature signal to the CPE prior to the first ring signal. Thus, any legacy CPE not configured to process an advanced calling feature signal ignores the advanced calling feature signal at least because the first ring signal has not been transmitted. Accordingly, providing advanced calling features through the signaling described according to the embodiments does not negatively affect legacy CPE on the same telephony line.

At 205, the CPE 111a-e that are configured to process an advanced calling feature signal ignore the first ring signal and subsequent ring signals if the advanced calling feature signal was received. Instead of generating the conventional ring, the CPE may generate a ring tone according to the instructions in the advanced calling feature signal. If the advanced calling feature signal was not received, then these CPE operate as conventional CPE to process the first ring signal and subsequent ring signals.

At 206, the CPE 111a-e connected to the loopline 140 stops ringing if any CPE goes off-hook. This includes CPE configured to process an advanced calling feature signal and legacy CPE. Then, a voice path is established between the caller and callee.

At 207, the EMTA 120 generates a caller ID FSK signal and transmits the signal on the loopline 140 to the CPE 111a-e. Any CPE 111a-e capable of processing the caller ID FSK signal processes the signal and may display the caller ID information.

At 208, after the caller ID FSK signal is transmitted, the EMTA 120 begins a second ring cycle if none of the CPE 111a-e are off-hook or if the call is not abandoned by the caller. The second ring cycle includes generating a second ring signal on the loopline 140. Legacy CPE receiving the second ring signal generate a conventional ring. CPE configured to process an advanced calling feature signal continue to provide the advanced calling feature, such as a customized ring tone, until the ring cycles cease.

At 209, the EMTA 120 continues to generate ring cycles until a CPE goes off hook or the caller abandons the call. At 210, the CPE 111a-e stops ringing when the ring cycles cease. This includes the CPE configured to process an advanced calling feature signal and the legacy CPE.

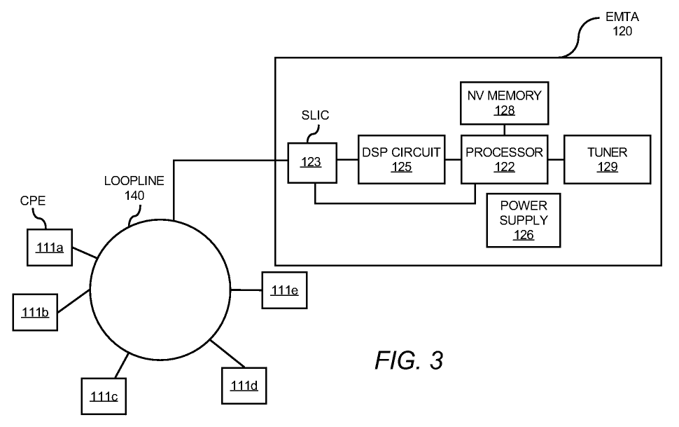

FIG. 3 illustrates a block diagram of the EMTA 120 configured to provide an advanced calling feature signal, according to an embodiment. The EMTA 120 may be provided at a customer premises as shown in FIG. 1.

The EMTA 120 includes a tuner 129, a digital signal processing (DSP) circuit 125, a processor 122, a subscriber line integrated circuit (SLIC) 123, a nonvolatile memory 128, and a power supply 126. The EMTA 120 may include other features not shown but known in the art. The EMTA 120, for example, receives a digital data sent via the network 105 shown in FIG. 1 and demodulates and formats the data for transmission on the loopline 140 and for use by the CPE 111a-e. For example, if the system 100 shown in FIG. 1 represents a cable network architecture, the processor 122 tunes the tuner 129 to receive high frequency cable (HFC) signals on predetermined channels carrying digital data, and the signals are demodulated as is known in the art. The DSP circuit 125 converts the received signals to frames for each channel.

The SLIC 123 emulates the functions of a telephony central office, as is known in the art, for providing VoIP services. The SLIC 123 generates the tip and ring voltages, i.e., the first ring signal and subsequent ring signals in ring cycles, on the loopline 140. When an incoming call is received at the EMTA 120, the processor 122 generates discrete data for transmission as the advanced calling feature signal on the loopline 140. The discrete data may include instructions for the CPE 111a-e to perform an advanced calling feature. The DSP circuit 125 and the SLIC 123 modulate the discrete data for transmission on the loopline 140. This may include FSK modulation. The NV memory 128 stores firmware for generating the advanced calling feature signal and for performing other functions.

In one embodiment, the processor 122 makes decisions as to the type of instruction that is transmitted. Decision making for sending data and instructions to CPE may be performed at the EMTA 120. For example, the EMTA 120 may include a database stored in data storage that includes caller ID data linked to certain media, such as a ringtone, video clip, picture, audio clip, etc. For example, an incoming telephone number 123-4567 is linked to certain media in the database, and the EMTA 120 sends instructions to CPE to play the media identified for the incoming telephone number. An incoming caller ID instruction can indicate a media clip, so if the CPE device has it, it will play it. The database can be configured by the local user, so certain incoming calls get mapped to their configuration and media. Each telephone may be configured differently for different users in the house.

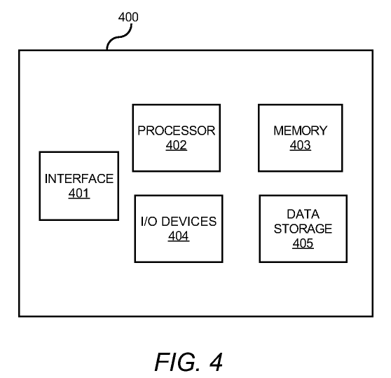

FIG. 4 illustrates a block diagram of a CPE 400 configured to process an advanced calling feature signal, according to an embodiment. The CPE 400 may be one or more of the CPE 111a-e connected to the loopline 140 shown in FIG. 1.

The CPE 400 includes an interface 401, a processor 402, a memory 403, and I/O devices 404. The CPE 400 may include other features as is known in the art. The interface 401 may include an RJ-11 interface connecting the CPE 400 to the loopline 140. According to an embodiment, the processor 402 is operable to process an advanced calling feature signal and provide advanced calling features in accordance with the signal. For example, if a received advanced calling feature signal may instruct the processor to generate a customized ring tone. The ring tone is generated on the I/O devices 404. The I/O devices may include a speaker, display, handset, etc. The memory 403 may store software executed by the processor. A data storage 405 in the CPE 400 may store ring tones, pictures, video clips or other multimedia for playing on the I/O devices 404. The processor 402 may provide a multimedia output via one or more I/O devices 404 in response to an incoming call. A multimedia output may include a picture or some other form of media and a ringtone.

One or more of the steps in the method 200 and other steps described herein and software described herein may be implemented as software embedded or stored on a computer readable medium. The steps may be embodied by a computer program, which may exist in a variety of forms both active and inactive. For example, they may exist as software program(s) comprised of program instructions in source code, object code, executable code or other formats for performing some of the steps when executed. Modules include software, such as programs, subroutines, objects, etc. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method of providing advanced calling features, the method comprising:
receiving an incoming call;
prior to transmitting a first ringing signal for the incoming call, transmitting an advanced calling feature signal to customer premises equipment (CPE) connected to a local line at the customer premises; and
transmitting the first ringing signal to the CPE via the local line.

2. The method of claim 1, wherein transmitting an advanced calling feature signal to CPE comprises:
using analog modulation to transmit the advanced calling feature signal on the local line.

3. The method of claim 2, wherein the analog modulation comprises frequency shift keying modulation.

4. The method of claim 2, wherein the local line comprises RJ-11 wiring.

5. The method of claim 1, wherein the advanced calling feature signal includes data that instructs the CPE to perform an advanced calling feature.

6. The method of claim 1, further comprising:
receiving the advanced calling feature signal at the CPE;
if the CPE is configured to provide advanced calling features, processing the advanced calling feature signal; and
providing an advanced calling feature in accordance with data provided in the advanced calling feature signal.

7. The method of claim 6, wherein the advanced calling feature comprises a customized ring tone, and the method further comprises:
ignoring the first ringing signal at the CPE; and
generating the customized ring tone at the CPE.

8. The method of claim 7, further comprising:
playing the customized ring tone until ring cycles generated on the local line in response to the incoming call cease.

9. The method of claim 6, further comprising:
if the CPE is not configured to provide advanced calling features, ignoring the advanced calling feature signal; and
ringing the CPE in response to receiving the first ringing signal.

10. A device configured to facilitate advanced calling features in CPE, the device comprising:
an interface connecting the device to a local line at a customer premises;
a processor detecting an incoming call and generating data for providing an advanced calling feature; and
a digital signal processing (DSP) circuit using an analog modulation technique to modulate the data for providing an advanced calling feature,
wherein an advanced calling feature signal comprised of the modulated data is transmitted by the device via the interface on the local line to the CPE.

11. The device of claim 10, wherein the device transmits the advanced calling feature signal prior to generating a first ring signal on the local line.

12. The device of claim 10, wherein the advanced calling feature includes providing a customized ring tone.

13. The device of claim 10, wherein the advanced calling feature includes providing a multimedia output via one or more I/O devices in the CPE.

14. The device of claim 10, wherein the device includes a multimedia terminal adapter.

15. The device of claim 10, wherein the device includes an embedded multimedia terminal adapter.

16. The device of claim 10, further comprising:
a database of caller IDs and media associated with each caller ID, and the processor is configured to receive an incoming call, parse the database with a caller ID for the incoming call, identify associated media from the database, and transmit the advanced calling feature signal to the CPE, wherein the advanced calling feature signal identifies the media to be played by the CPE to notify of the incoming call.

17. A CPE connected to a local line at a customer premises and being configured to provide advanced calling features, the CPE comprising:
an interface connecting the CPE to a local line at a customer premises;
a processor receiving an advanced calling feature signal transmitted prior to a first ring signal and providing an advanced calling feature in accordance with the advanced calling feature signal; and
an I/O device providing output associated with the advanced calling feature.

18. The CPE of claim 17, wherein the advanced calling feature includes providing a customized ring tone.

19. The CPE of claim 17, wherein the advanced calling feature includes providing a multimedia output via the I/O device in the CPE.

20. The CPE of claim 17, wherein the advanced calling feature signal identifies media to be played by the I/O device in response to an incoming call.
